(19) United States
(12) Patent Application Publication
(10) Pub. No.: US 2003/0125012 A1
(43) Pub. Date: Jul. 3, 2003

(54) Micro-credit certificate for access to services on heterogeneous access networks

(76) Inventors: Lee S. Allen, San Jose, CA (US); Toshio Miki, Cupertino, CA (US)

Correspondence Address: BRINKS HOFER GILSON & LIONE, ONE INDIANA SQUARE, SUITE 1600, INDIANAPOLIS, IN, 46204-2033, US

(21) Appl. No.: 10/190,808

(22) Filed: Jul. 8, 2002

Related U.S. Application Data
(60) Provisional application No. 60/344,301, filed on Dec. 28, 2001.

(51) Int. Cl. H04M 11/00

(52) U.S. Cl. 455/406; 455/408

(57) ABSTRACT

A method and system for conducting transactions in a wireless communication system using a micro-credit certificate. A temporary certificate is issued to a mobile node. The temporary certificate is presented to a heterogeneous access network. The mobile node is authenticated using the temporary certificate. A service is then accessed with the mobile node. A credit amount associated with the mobile node for accessing the service is then deducted from the credit amount associated with the temporary certificate.

This application claims the benefit of U.S. Provisional Application Serial No. 60/344,301, filed Dec. 28, 2001.

### FIELD OF THE INVENTION

The present invention relates generally to providing access to heterogeneous access networks and more particularly, to a system and method for securely providing accounting and settlement mechanisms for mobile nodes accessing service or content on heterogeneous access networks.

### BACKGROUND OF THE PRESENT INVENTION

Mobile nodes in wireless communication systems have traditionally been connected to only one network operator or access network. Some network operators provide enhanced services, but these services have been relatively limited. Emerging mobile virtual network operators (MVNO) will make a wide variety of services available to their customers through mobile nodes. These services will be provided by many different third parties, including many different infrastructure operators in heterogeneous access environments. Users of mobile nodes will contract with one provider and will expect all dealings to be with that provider, regardless of how many operators or access networks are involved in the provision of services.

MVNOs will use heterogeneous access network providers to provide access to their virtual networks through a variety of access methods, such as wireless LAN and Bluetooth. During a session, only one or perhaps several access providers may be involved in providing connectivity or services to their customers. The customer will have little or no interest in the details (other than services level and cost) of how each individual session is enabled. Further, the business agreements made with and between various operators are expected to change on some timescale, which will be determined by the business environment.

When the network operator is the only service and content provider it is relatively simple to keep track of accounting and settlement. The emergence of multi-operator heterogeneous access networks raises many issues. These issues include settlement amongst resource providers, authentication of the customer, authorization for the service in question, event recording and reporting, and accounting of resources used by the mobile node.

### SUMMARY OF THE PRESENT INVENTION

A preferred embodiment of the present invention discloses a method for conducting transactions in a wireless communication network. In this preferred method, a temporary certificate with a predetermined credit limit is issued to a respective mobile node. During operation, the temporary certificate is presented to a heterogeneous access network. A service provided through the heterogeneous access network is then accessed with the mobile node if the credit limit is sufficient to cover costs associated with accessing the service.

A payment request is then issued from the heterogeneous access network to a mobile virtual network operator to cover costs of providing the service. A payment is then issued by the mobile virtual network operator to the heterogeneous access network to pay for the costs of providing the service to the mobile node. In another embodiment of the present invention, payment for the service is deducted directly from the temporary certificate by the heterogeneous access network.

In the preferred embodiment, the temporary certificate is issued by a mobile virtual network operator. A digital signature and a public encryption key may also be issued with the temporary certificate. The mobile node may be authenticated with the temporary certificate on the heterogeneous access network. As such, the temporary certificate can be used to save time and speed up access to services provided by the heterogeneous access network.

In yet another preferred embodiment, a service provider connected to the heterogeneous access network may actually provide the service to the mobile node. In this embodiment, a payment request is issued from the service provider to a mobile virtual network operator to cover costs of providing the service. As such, a payment would be issued from the mobile virtual network operator to the service provider for the service.

Another preferred embodiment of the present invention discloses a micro-credit certificate system for a wireless communication network. In this embodiment, a mobile node is connected to a mobile virtual network operator. A certificate database located on the mobile virtual network operator contains at least one temporary certificate that is associated with the mobile node, wherein during operation the temporary certificate is issued to the mobile node and a credit limit is associated with the temporary certificate. At least one heterogeneous access network is preferentially within radio range of the mobile node. The mobile node preferentially transmits the temporary certificate to the heterogeneous access network for access to a respective service. The heterogeneous access network then provides access to the service to the mobile node if the credit limit is sufficient to cover costs associated with the access purchase.

In this embodiment, a payment request is issued by the heterogeneous access network and sent to the mobile virtual network operator for the service. A payment is then sent by the mobile virtual network operator to the heterogeneous access network to cover the costs associated with the service. In another embodiment, a credit amount is deducted directly from the temporary certificate to cover the costs associated with the service. As such, this eliminates the need for the mobile virtual network operator to pay the heterogeneous access network for the service.

Further objects and advantages of the present invention will be apparent from the following description, reference being made to the accompanying drawings wherein preferred embodiments of the invention are clearly illustrated.

### DESCRIPTION OF THE DRAWINGS

FIG. 1 illustrates a mobile node connected to a mobile virtual network operator and a plurality of heterogeneous access networks.

FIG. 2 illustrates a temporary certificate being issued to a mobile node from a certificate database.

FIG. 3 illustrates a temporary certificate being presented to a heterogeneous access network.

FIG. 4 illustrates a payment process between a mobile virtual network operator and a heterogeneous access network.

FIG. 5 illustrates a payment process between a mobile virtual network operator and a service provider.

### DETAILED DESCRIPTION OF THE PRESENTLY PREFERRED EMBODIMENTS OF THE INVENTION

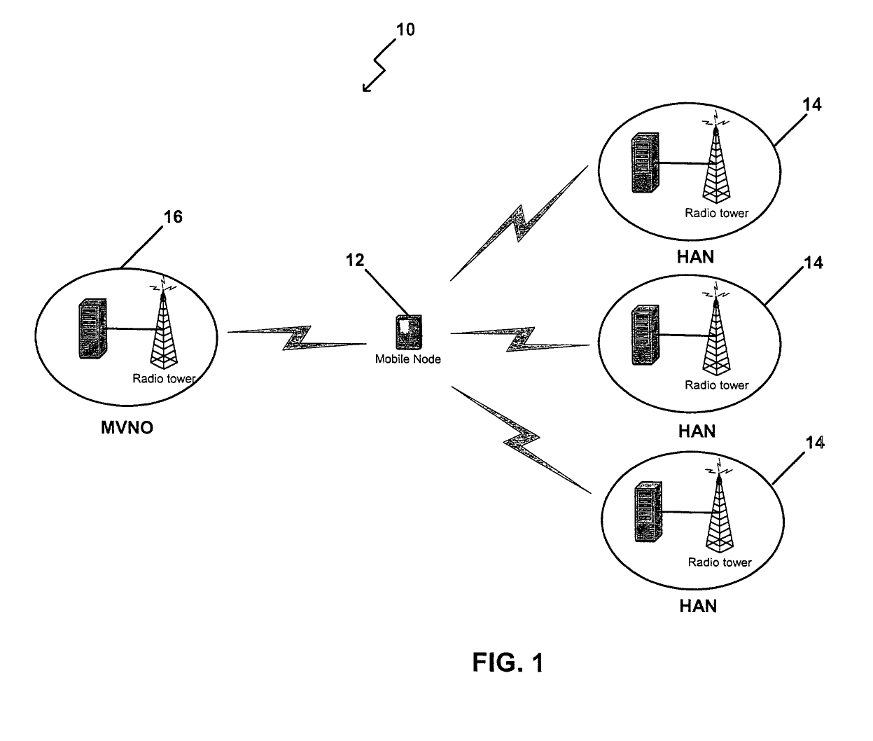

Referring to FIG. 1, a preferred embodiment of the present invention discloses a micro-credit certificate system 10 for a plurality of mobile nodes 12 accessing wireless communication services and content provided through a plurality of heterogeneous access networks (HANs) 14. Each mobile node 12 is connected to a mobile virtual network operator (MVNO) 16. The MVNO 16 is capable of providing a wide variety of services to the mobile nodes 12, which are also provided by many different third-parties through HANs 14 that are controlled and operated by the respective third-parties.

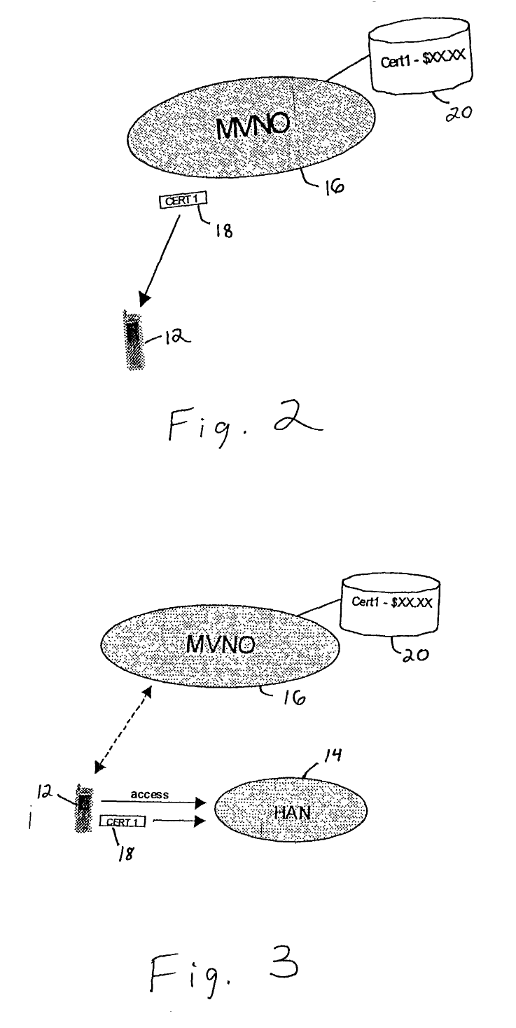

Referring to FIG. 2, upon connecting to the MVNO 16, and periodically thereafter, the MVNO 16 issues a temporary certificate 18 to the mobile node 12 that uniquely identifies the customer and the session. Associated with the temporary certificate 18 is a credit limit. The temporary certificate 18 is preferentially obtained from a certificate database 20 that is associated with and connected to the MVNO 16. The temporary certificate 18 may be delivered via wireless communication to the mobile node 12 or by some other means, such as a smart-card that is updated at a kiosk and subsequently attached to the mobile node 12.

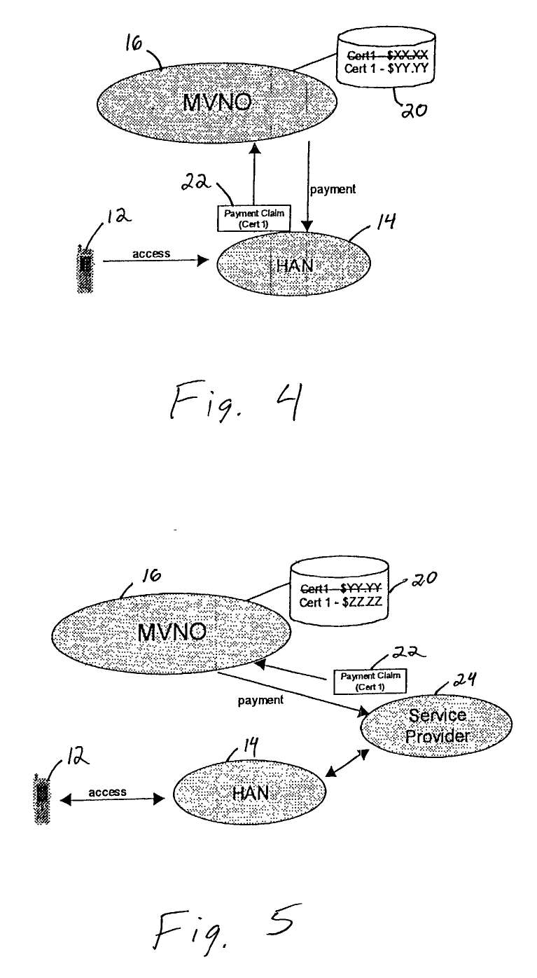

As illustrated in FIG. 3, when a customer gains access to a respective HAN 14 the temporary certificate 18 is presented or transmitted to the HAN 14 as proof of authentication of the customer and authorization for the cost associated with accessing whatever services or content that are being provided by the HAN 14. Referring to FIG. 4, if the credit balance associated with the temporary certificate 18 is sufficient to pay the cost associated with accessing the service or content requested by the user of the mobile node 12, the cost of the access purchased is deducted from the customer's credit balance and added to the access provider's account. As such, the HAN 14 that is providing service or content to the mobile node 12 issues a payment claim 22, which is associated with the temporary certificate 18, to the MVNO 16, which in turn, issues a payment to the respective HAN 14. The credit balance in the certificate database 20 is also reduced corresponding to the cost associated with the access purchased b the mobile node 12. Authentication for the transaction is preferentially accomplished through a digital signature and a public encryption key that is associated with each mobile node 12 and temporary certificate 18.

Referring to FIG. 5, in yet another preferred embodiment of the present invention the HAN 14 may also be connected to a service provider 24 that provides service or content to the mobile node 12 through the HAN 14. In this preferred embodiment, if the credit balance associated with the temporary certificate 18 is sufficient to pay the cost associated with accessing the service or content requested by the user of the mobile node 12, the cost of the access purchased is deducted from the customer's credit balance and added to an account of the service provider 24. As such, the service provider 24 that is providing service or content to the mobile node 12 through the HAN 14 issues a payment claim 22 that is associated with the temporary certificate 18 to the MVNO 16, which in turn, issues a payment to the service provider 24.

If an authorization check is not successful, the MVNO 16 is notified by the HAN 14 or service provider 24 and the temporary certificate is checked for validity. If the temporary certificate 18 is valid, but the credit is exhausted, MVNO 16 policies are followed. For example, a new temporary certificate 18 may be issued or the customer may be prohibited from further purchases for a time specified by the MVNO 16.

In the preferred embodiments set forth above, the certificate database 20 that is connected to the MVNO 16 keeps track of the credit balance that is associated with each temporary certificate 18 that is issued to respective mobile nodes 12 by the MVNO 16. As such, as credit amounts are deducted from a user's account this information is passed back to the MVNO 16, which then updates the user's account information accordingly. This requires the HANs 14 or service providers 24 to communicate with the MVNO 16 during operation in order to receive payment and in order for the MVNO 16 to be aware of the charges associated with the service or content that is being provided to the mobile node 12.

In yet another preferred embodiment of the present invention, the temporary certificate 18 is issued with a credit balance that stays or is associated with the temporary certificate 18 as it is used by the mobile node 12. As such, when the mobile node 12 gains access to a respective HAN 14 or service provider 24, the temporary certificate 18 is presented as proof of authentication of the customer and the current balance of the temporary certificate 18 is presented for comparison to the cost associated with the access purchase. If the balance associated with the temporary certificate 18 is sufficient to pay the price of the access purchase, the price of the access purchase is deducted from the credit balance on the temporary certificate 18 and the account associated with the HAN 14 or service provider 24 is credited the appropriate amount, without the need of communicating with the MVNO 16. Authentication for the transaction is also accomplished via digital signatures and the user's public encryption key that is associated with that respective mobile node 12.

The present invention uses non-persistent temporary certificates that provide credit on the customer's behalf for use in purchasing access, services and content through various HANs 14 or service providers 24. Customers receive dynamically issued incremental credit allowances and session-identification certificates, for use in purchasing access, content and services through each respective HAN 14 or service provider 24. The present invention allows the mobile node 12 to be persistently identified and authenticated, after the mobile node 12 has been initially authenticated by the users MVNO 16 through the user's purchase activities in a session. In addition, the present invention provides the HAN 14 or content provider 24 with limited exposure to fraud and a secure payment mechanism. As used herein and in the claims that follow, the term service should be construed broadly to include both services and content.

While the invention has been described in its currently best-known modes of operation and embodiments, other modes, embodiments and advantages of the present invention will be apparent to those skilled in the art and are contemplated herein.

What is claimed is:

1. A method for conducting transactions in a wireless communication system, comprising the steps of:
issuing a temporary certificate with a credit limit to a mobile node;
presenting said temporary certificate to a heterogeneous access network; and
accessing a service provided through said heterogeneous access network with said mobile node if said credit limit is sufficient to cover costs associated with accessing said service.

2. The method of claim 1, further comprising the step of issuing a payment request from said heterogeneous access network to a mobile virtual network operator to cover costs of providing said service.

3. The method of claim 2, further comprising the step of issuing a payment from said mobile virtual network operator to said heterogeneous access network for said service.

4. The method of claim 1, further comprising the step of deducting a payment for said service from said temporary certificate with said heterogeneous access network.

5. The method of claim 1, wherein said temporary certificate is issued by a mobile virtual network operator.

6. The method of claim 1, further comprising the step of issuing a digital signature with said temporary certificate.

7. The method of claim 1, further comprising the step of issuing a public encryption key with said temporary certificate.

8. The method of claim 1, further comprising the step of authenticating said mobile node with said temporary certificate on said heterogeneous access network.

9. The method of claim 1, wherein said service is provided by a service provider connected to said heterogeneous access network.

10. The method of claim 9, further comprising the step of issuing a payment request from said service provider to a mobile virtual network operator to cover costs of providing said service.

11. The method of claim 10, further comprising the step of issuing a payment from said mobile virtual network operator to said service provider for said service.

12. A micro-credit certificate system for a wireless communication system, comprising:
a mobile node connected to a mobile virtual network operator;
a certificate database located on said mobile virtual network operator that contains a temporary certificate associated with said mobile node, wherein said temporary certificate is issued to said mobile node and a credit limit is associated with said temporary certificate;
at least one heterogeneous access network within radio range of said mobile node, wherein said mobile node transmits said temporary certificate to said heterogeneous access network for access to a respective service; and
wherein said heterogeneous access network provides access to said service to said mobile node if said credit limit is sufficient to cover costs associated with said access purchase.

13. The micro-credit certificate system for a wireless communication system of claim 12, wherein a payment request is issued by said heterogeneous access network and sent to said mobile virtual network operator for said service.

14. The micro-credit certificate system for a wireless communication system of claim 13, wherein a payment is sent by said mobile virtual network operator to said heterogeneous access network.

15. The micro-credit certificate system for a wireless communication system of claim 12, wherein a credit amount is deducted from said temporary certificate to cover costs of said service.

16. The micro-credit certificate system for a wireless communication system of claim 12, wherein a digital signature is issued with said temporary certificate.

17. The micro-credit certificate system for a wireless communication system of claim 12, wherein a public encryption key is issued with said temporary certificate.

18. The micro-credit certificate system for a wireless communication system of claim 12, wherein said mobile node is authenticated on said heterogeneous access network with said temporary certificate.

19. A method of processing transactions in a wireless communication network, comprising the steps of:
generating a temporary certificate having a predetermined credit limit with a mobile virtual network operator;
transmitting said temporary certificate to a mobile node;
presenting said temporary certificate to a heterogeneous access network to obtain access to a predetermined service; and
deducting an access purchase amount from said temporary certificate with said heterogeneous access network.

20. The method of claim 19, further comprising the step of issuing a digital signature with said temporary certificate.

21. The method of claim 19, further comprising the step of issuing a public encryption key with said temporary certificate.

22. The method of claim 19, further comprising the step of authenticating said mobile node with said temporary certificate on said heterogeneous access network.

23. The method of claim 19, wherein said service is provided by a service provider connected to said heterogeneous access network.
